(19) United States
(12) Patent Application Publication
(10) Pub. No.: US 2016/0063417 A1
(43) Pub. Date: Mar. 3, 2016

(54) LIFE CYCLE MANAGEMENT FOR AN ASSET

(71) Applicant: International Business Machines Corporation, Armonk, NY (US)

(72) Inventors: Baiju D. Mandalia, Boca Raton, FL (US); Madhusudan Ramakrishna, Bangalore (IN)

(21) Appl. No.: 14/475,636

(22) Filed: Sep. 3, 2014

(51) Int. Cl. G06Q 10/06; H04L 12/26; H04L 12/24; G06F 17/30

(52) U.S. Cl. CPC G06Q 10/06315; G06F 17/3053; H04L 43/04; H04L 41/0613

(57) ABSTRACT

In a method for managing assets in a computing environment, one or more processors identifying a first memory page in a listing of memory pages in a server. The method further includes one or more processors identifying a set of information that is associated with a life span of an asset, wherein the asset is a hardware asset or a software asset. The method further includes one or more processors determining a weighted rating for the asset based on the identified set of information that is associated with the life span of the asset. The method further includes one or more processors determining a replacement age for the asset based on the determined weighted rating for the asset. The method further includes one or more processors determining whether to provide an alert indicating information associated with replacing the asset.

### BACKGROUND OF THE INVENTION

The present invention relates generally to the field of resource management, and more particularly to life cycle management for an asset.

Hardware and software assets in an organization have a finite life span (e.g., 10 years). Hardware failures of any type of system (e.g., server computers, mobile device, household appliances, microwave ovens, etc.) can occur at any point during the life cycle of an asset. Software assets may also have a finite life span, which can be influenced by a high number of software updates/patches, a reduction in product support, or other factors. In many examples, the supplier of a hardware or software asset can provide an expected lifespan for the asset. Repair activity can occur on hardware and software assets of an organization (e.g., by maintenance staff associated with the assets and/or the organization), which can occur in response to a failure in the asset or at scheduled intervals.

For example, a data center can be comprised of multiple server computers, personal computers, mobile devices, and other types of hardware associated with the operation of the data center. Each device and component of the data center can have an associated life span. If a device (e.g., a server computer) in the data center experiences a failure, then the data center will have to repair or replace the device in order to continue operating in the same capacity.

### SUMMARY

Aspects of the present invention disclose a method, computer program product, and system for managing assets in a computing environment. The method includes one or more processors identifying a set of information that is associated with a life span of an asset, wherein the asset is a hardware asset or a software asset. The method further includes one or more processors determining a weighted rating for the asset based on the identified set of information that is associated with the life span of the asset. The method further includes one or more processors determining a replacement age for the asset based on the determined weighted rating for the asset. The method further includes one or more processors determining whether to provide an alert indicating information associated with replacing the asset.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for managing life span information for assets and providing alerts associated with the life span of assets, in accordance with an embodiment of the present invention.

FIGS. 3A and 3B depict example tables that include information corresponding to events associated with an asset that may affect the product life span of the asset.

FIG. 4 depicts a block diagram of components of a computing system representative of the client device and server of FIG. 1, in accordance with an embodiment of the present invention.

### DETAILED DESCRIPTION

Embodiments of the present invention allow for an asset management service. Repair activities are tracked for assets in an organization, which can include hardware or software assets of an organization. Each asset in an organization can have a corresponding estimated life span. A rating is determined for an asset based on information associated with the life span of the asset, and a life span adjustment factor is determined for the asset based on the determined rating. A replacement age for the asset is determined and provided to an individual associated with the asset.

Some embodiments of the present invention recognize that repair activity on an asset (hardware and/or software) is a factor that impacts the life span of the asset. The life span of an asset can be impacted by a plurality of factors, such as environmental history, a repair activity, a manufacturer recall, complaints associated with the asset, as well as other factors. Even though a provider of an asset provides an estimated life span of the asset, repair activity or other factors can lead to a decrease in the life span of the asset.

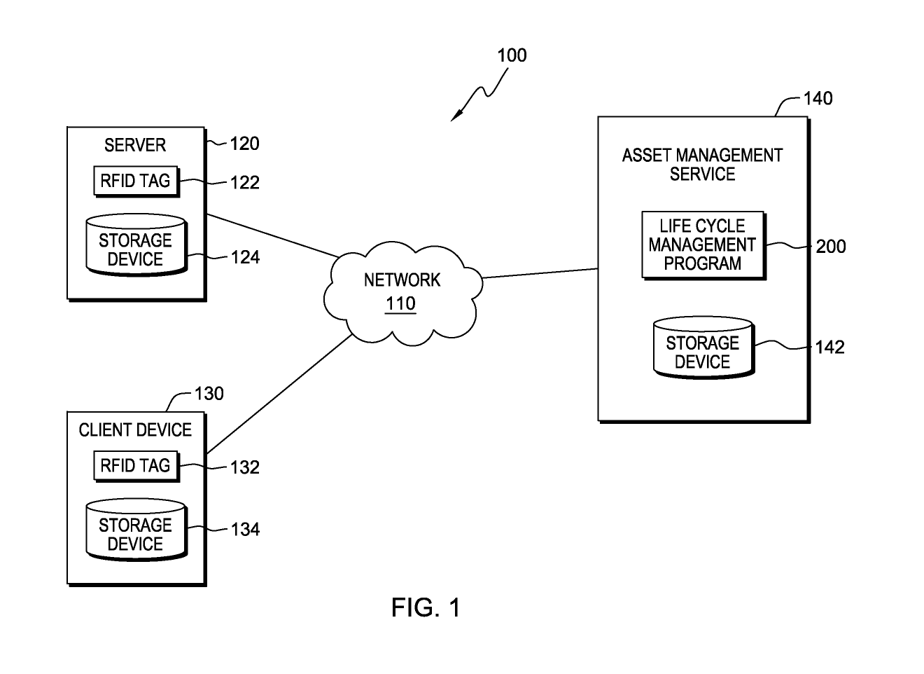

The present invention will now be described in detail with reference to the Figures. FIG. 1 is a functional block diagram illustrating a distributed data processing environment, generally designated 100, in accordance with one embodiment of the present invention.

An embodiment of data processing environment 100 includes server 120, client device 130, and asset management service 140, all interconnected over network 110. In one embodiment, data processing environment 100 is representative of a networked computing environment of an organization and computing assets included in the environment. For example, data processing environment 100 can be a data center of an enterprise or an organization, including server computers and other computer devices associated with the data center (e.g., server 120, client device 130, etc.). In additional embodiments, data processing environment 100 can include additional servers and client devices (not shown).

In one embodiment, server 120, client device 130, and asset management service 140 communicate through network 110. Network 110 can be, for example, a local area network (LAN), a telecommunications network, a wide area network (WAN) such as the Internet, or any combination of the three, and include wired, wireless, or fiber optic connections. In general, network 110 can be any combination of connections and protocols that will support communications between server 120, client device 130, and asset management service 140, in accordance with embodiments of the present invention.

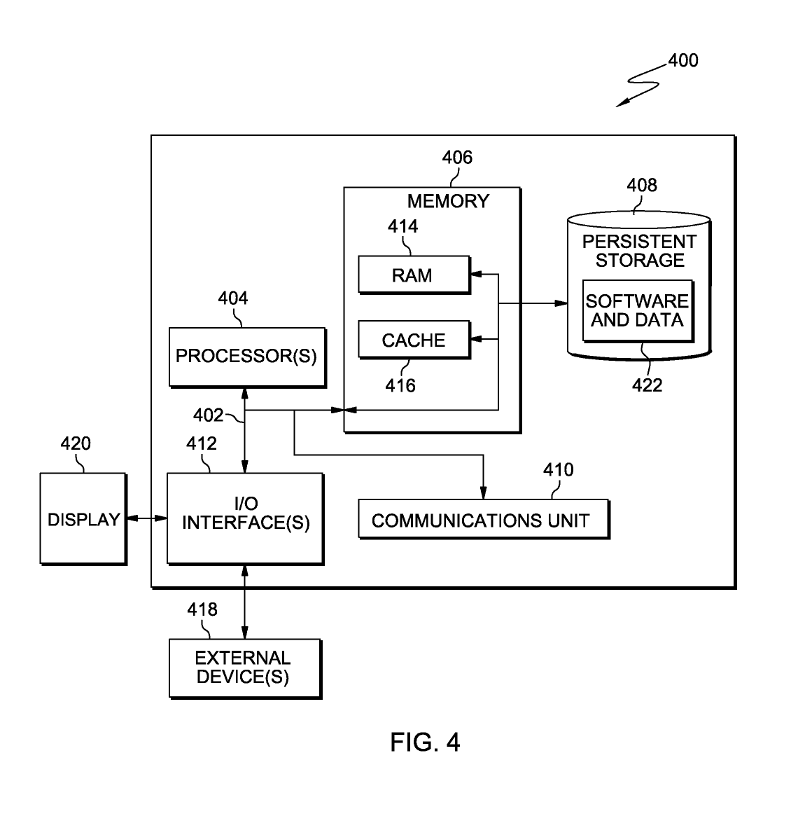

In example embodiments, server 120 can be a desktop computer, a computer server, or any other computer system known in the art. In certain embodiments, server 120 represent a computer system utilizing clustered computers and components (e.g., database server computers, application server computers, etc.) that act as a single pool of seamless resources when accessed by elements of data processing environment 100 (e.g., server 120, client device 130, and asset management service 140). In general, server 120 is representative of any electronic device or combination of electronic devices capable of executing computer readable program instructions. Server 120 may include components as depicted and described in further detail with respect to FIG. 4, in accordance with embodiments of the present invention.

Server 120 includes radio-frequency identification (RFID) tag 122 and storage device 124. In one embodiment, RFID tag 122 provides identification information corresponding to server 120 (e.g., via near field communication (NFC), etc.), which allows an individual associated with server (e.g., maintenance staff) to identify the specific instance of server 120. In another embodiment, RFID tag 122 provides an identification tag that associates information corresponding to server 120 (e.g., on storage device 124) to server 120. For example, historical repair activity information stored on storage device 124 of server 120 is associated with an identifier provided by RFID tag 122.

Storage device 124 can be implemented with any type of storage device, for example, persistent storage 408, which is capable of storing data that may be accessed and utilized by server 120, client device 130, and asset management service 140, such as a database server, a hard disk drive, or a flash memory. In other embodiments, storage device 124 can represent multiple storage devices within server 120. Storage device 124 stores information corresponding to events associated with server 120 that may affect the product life span of server 120. In example embodiments, the information stored in storage device 124 can be sorted into event categories that group similar events together. For example, event categories can include environment factors (e.g., air condition failures in a data center, historical cooling issues, etc.), recall events (e.g., a product recall of components of server 120, a recall of a product from the manufacturer of server 120, etc.), complaints (e.g., negative product reviews associated with server 120, third-party complaints, etc.), and repair events (e.g., replacing computer memory in server 120, etc.). In other embodiments, storage device 124 can include information sorted into additional event categories, which may be specific to a use of server 120 or another characteristic of server 120. In additional embodiments, storage device 124 includes information corresponding to events associated with components (e.g., software and hardware components) of server 120 that may affect the product life span of server 120 or the components.

In various embodiments of the present invention, client device 130 may be a workstation, personal computer, personal digital assistant, mobile phone, or any other device capable of executing computer readable program instructions, in accordance with embodiments of the present invention. In general, client device 130 is representative of any electronic device or combination of electronic devices capable of executing computer readable program instructions. Client device 130 may include components as depicted and described in further detail with respect to FIG. 4, in accordance with embodiments of the present invention.

Client device 130 includes RFID tag 132 and storage device 134. In one embodiment, RFID tag 132 provides identification information corresponding to client device 130 (e.g., via near field communication (NFC), etc.), which allows an individual associated with server (e.g., maintenance staff) to identify the specific instance of client device 130. In another embodiment, RFID tag 132 provides an identification tag that associates information corresponding to client device 130 (e.g., on storage device 134) to client device 130. For example, historical repair activity information stored on storage device 134 of client device 130 is associated with an identifier provided by RFID tag 132.

Storage device 134 can be implemented with any type of storage device, for example, persistent storage 408, which is capable of storing data that may be accessed and utilized by server 120, client device 130, and asset management service 140, such as a database server, a hard disk drive, or a flash memory. In other embodiments, storage device 134 can represent multiple storage devices within client device 130. Storage device 134 stores information corresponding to events associated with client device 130 that may affect the product life span of client device 130 (similar to information previously discussed with regard to storage device 124).

In example embodiments, asset management service 140 can be a desktop computer, computer server, or any other computer system known in the art. In certain embodiments, asset management service 140 represents a computer system utilizing clustered computers and components (e.g., database server computers, application server computers, etc.) that act as a single pool of seamless resources when accessed by elements of data processing environment 100 (e.g., server 120, client device 130, and asset management service 140). In general, asset management service 140 is representative of any electronic device or combination of electronic devices capable of executing computer readable program instructions. Asset management service 140 may include components as depicted and described in further detail with respect to FIG. 4, in accordance with embodiments of the present invention.

In example embodiments, asset management service 140 tracks and manages life span information associated with assets in data processing environment 100 (i.e., server 120 and client device 130). Asset management server 140 includes life cycle management program 200 and storage device 142. Storage device 142 can be implemented with any type of storage device, for example, persistent storage 408, which is capable of storing data that may be accessed and utilized by server 120, client device 130, and asset management service 140, such as a database server, a hard disk drive, or a flash memory. In other embodiments, storage device 142 can represent multiple storage devices within asset management service 140. In one embodiment, storage device 142 stores information associated with the product life span of server 120, client device 130, and additional assets in data processing environment 100 (not shown). For example, storage device 142 includes identification information (e.g., RFID tags 122 and 132) for assets, manufacturer provided life span estimates for assets, and other forms of information. Life cycle management program 200 manages life span information for assets and provides alerts associated with the life span of assets in data processing environment 100, in accordance with embodiments of the present invention.

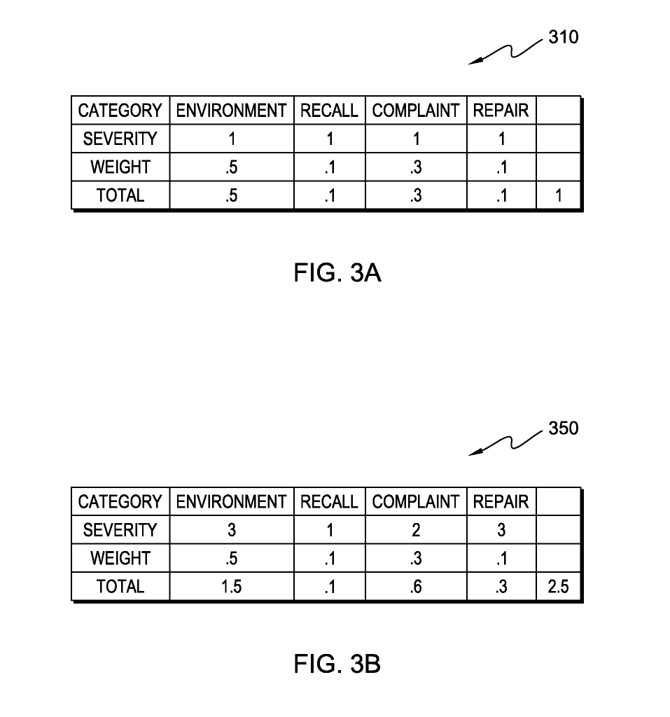

FIGS. 3A and 3B are example depictions of a table that includes information corresponding to events associated with server 120 that may affect the product life span of server 120, which can be stored in storage device 124. In another embodiment, FIGS. 3A and 3B can be example depictions of information stored in storage device 134 and corresponding to client device 130. FIG. 3A depicts baseline event information 310, which includes event information indicating no events that affect the life span of server 120 (i.e., a baseline measurement of the life span of server 120). FIG. 3B depicts example event information 350, which includes information corresponding to events associated with server 120.

In one embodiment, each category of event information (e.g., environment, recall, complaint, repair, etc.) has a corresponding “severity” rating and “weight” factor. In FIGS. 3A and 3B, the columns of “environment,” “recall,” “complaint,” and “repair” are event categories. Each event category has a corresponding entry in the “severity” row of a rating on a scale of 1-10 (1 being normal, and 10 being a high amount of the corresponding event). One or more individuals associated with server 120 (e.g., maintenance staff in data processing environment 100, etc.) populates the information in the severity row with ratings based on the history of the asset (e.g., server 120 or client device 130) and events associated with the life span of the asset.

For example, in baseline event information 310 the severity entry in the repair column is “1,” which indicates that no repair events are associated with server 120. Then in example event information 350, the severity entry in the repair column is “3,” which indicates that the maintenance staff has assigned a severity rating of 3 to the repair events associated with server 120. In this example, in response to making a series of repairs to server 120, the maintenance staff incremented the severity rating for repair events from “1” (in baseline event information 310) to “3” (in example event information 350). In additional examples, severity ratings can be assigned at the discretion and judgment of the maintenance staff (or other individuals) or can correspond to a number of events occurring in the corresponding event category (e.g., three repair events equals a “3” repair severity rating, four complaints equals a “2” complaint severity rating, or other forms of rating scales). In various embodiments, a high rating for the “environment” category corresponds to poor environmental conditions that server 120 is operating in (e.g., poor cooling, etc.), a high rating for the “recall” category corresponds to a high occurrence of manufacturer recalls associated with server 120, a high rating for the “complaint” columns corresponds to a high rate of complaints associated with server 120 (e.g., in reviews by a third-party, etc.), and a high rating for the “repair” column corresponds to a high frequency of repair events associated with server 120 (a rating of 10 being the worst for each category, and a rating of “1” being the best).

Each event category has a corresponding entry in the “weight” row of a weighting factor that corresponds to the event category (with the total for all the weighting factors summing up to 1). The weighting factors are associated with a significance of the corresponding event category to the asset (e.g., server 120, client device 130, etc.). For example, in example event information 350 the environment weighting factor is “0.5,” the recall weighting factor is “0.1,” the complaint weighting factor is “0.3,” and the repair weighting factor is “0.1” (the same as baseline event information 310). In various embodiments, the weighting factors may vary depending on an individual asset (e.g., different weighting factors for environment based on different operating environments for assets). In other embodiments, RFID tags 122 and 132 provide identification information for server 120 and client device 130, respectively, that an individual can utilize in the process of recording event information for the assets.

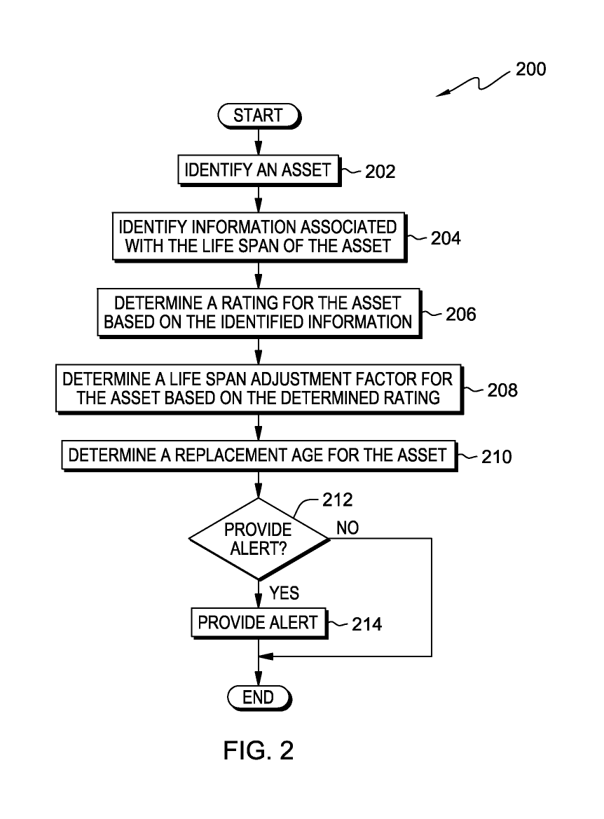

FIG. 2 is a flowchart depicting operational steps of life cycle management program 200, a program for managing life span information for assets and providing alerts associated with the life span of assets, in accordance with an embodiment of the present invention. In one embodiment, life cycle management program 200 initiates in response to receiving input of an event into an asset (e.g., maintenance staff inputting information into storage device 124 of server 120) or an update to a severity rating (e.g., in storage device 124 of server 120, etc.). In another embodiment, life cycle management program 200 initiates periodically (e.g., daily, weekly, etc.). In yet another embodiment, life cycle management program 200 initiates in response to a user request (e.g., a system administrator).

In step 202, life cycle management program 200 identifies an asset. In one embodiment, life cycle management program 200 identifies an asset of an organization or enterprise (e.g., data processing environment 100), which can be a hardware asset (e.g., server 120, client device 130, a hardware component of server 120, etc.) or a software asset (e.g., an operating system of client device 130, software installed on server 120, etc.). In an example embodiment where life cycle management program 200 initiates periodically, life cycle management program 200 can repeat for each asset in (e.g., each asset in data processing environment 100, each asset in a predefined listing of assets, etc.) or separate instances of life cycle management program 200 operate simultaneously for each asset. In another embodiment, life cycle management program 200 utilizes RFID tag 122 to identify server 120 or RFID tag 132 to identify client device 130.

In step 204, life cycle management program 200 identifies information associated with the life span of the asset. In one embodiment, life cycle management program 200 identifies information (e.g., stored in storage devices 124, 134, and 142) that is associated with the identified asset (identified in step 202). Life cycle management program 200 identifies information that includes, but is not limited to, information corresponding to events associated with an asset that may affect the product life span of the asset (e.g., ratings and scores corresponding to the history of an asset, etc.) and an estimated life span of the asset (e.g., provided by the manufacturer of the asset). In another embodiment, life cycle management program 200 identifies information that is associated with RFID tag 122, which corresponds to server 120.

In an example, life cycle management program 200 identifies server 120 (in step 202) and then identifies information associated with the life span of server 120 (e.g., stored in storage devices 124 and 134). In this example, life cycle management program 200 identifies example event information 350, which includes information associated with the life span of server 120 and is stored in storage device 124 of server 120. Example event information 350 includes “severity” ratings and “weight” factors for event categories corresponding to server 120. Life cycle management program 200 also identifies an estimated life span corresponding to server 120 of 10 years (e.g., an estimated lifespan for server 120 provided by the manufacturer that is stored in storage device 142). In additional example embodiments, life cycle management program 200 can identify additional or alternative forms of information that is associated with the life span of an asset.

In step 206, life cycle management program 200 determines a rating for the asset based on the identified information. More specifically, life cycle management program 200 determines a rating for the asset (identified in step 202) based on the identified information associated with the life span of the asset (identified in step 204). In one embodiment, life cycle management program 200 utilizes a weighted algorithm (e.g., based on weighting factors) to determine a rating for the asset. In various embodiments, the weighted algorithm can be previously defined and be specific to the asset (e.g., server 120) or the organization that utilizes the asset (e.g., data processing environment 100). In another embodiment, life cycle management program 200 utilizes other forms of information that relates to aging considerations for an asset to determine a rating corresponding to the aging of the asset.

In the previously discussed example, life cycle management program 200 identifies server 120 (in step 202) and identifies example event information 350 (in step 204) as the information associated with the life span of server 120. In this example, life cycle management program 200 utilizes a weighted algorithm of (Environment Rating)×(Environment Weight)+(Recall Rating)×(Recall Weight)+(Complaint Rating)×(Complaint Weight)+(Repair Rating)×(Repair Weight)=Total Weighted Rating. Life cycle management program 200 determines a total weighted rating of (3)×(0.5)+(1)×(0.1)+(2)×(0.3)+(3)×(0.1)=2.5. In another example embodiment, life cycle management program 200 determines a weighted rating for each event category and then calculates a sum of each weighted rating to determine a total weighted rating (e.g., for the environment column (3)×(0.5)=1.5, etc. and a total weighted rating of 2.5).

In step 208, life cycle management program 200 determines a life span adjustment factor for the asset based on the determined rating. More specifically, life cycle management program 200 determines a life span adjustment factor based on the determined rating from step 206. In one embodiment, life cycle management program 200 determines the life span adjustment factor to be the multiplicative inverse, or reciprocal, of the determined total weighted rating. In other embodiments, life cycle management program 200 can utilize another algorithm or operation to determine a life span adjustment factor. In the previously discussed example, life cycle management program 200 utilizes the total weighted rating of 2.5 (for example event information 350) to determine a life span adjustment factor of “0.4” (i.e., 1/2.5=0.4).

In step 210, life cycle management program 200 determines a replacement age for the asset. More specifically, life cycle management program 200 determines a replacement age for the asset (identified in step 202) utilizing the determined life span adjustment factor (from step 208). In one embodiment, life cycle management program 200 determines the replacement age for the asset utilizing the estimated life span for the asset (identified in step 204) and the determined life span adjustment factor (from step 208). In the previously discussed example, life cycle management program 200 multiplies the estimated life span for the asset with the determined life span adjustment factor to determine a replacement age of 4 years (i.e., (10 years)×(0.4)=4 years).

In decision step 212, life cycle management program 200 determines whether to provide an alert. In one embodiment, life cycle management program 200 compares the determined replacement age for the asset (determined in step 210) to the actual age of the asset and a threshold condition. In various embodiments, the threshold condition is previously defined and can be defined in user preferences (e.g., of an organization or individuals associated with the asset). For example, the threshold condition can be a minimum amount of time (e.g., 6 months, 1 year, etc.). In another embodiment, the actual age of the asset can be the asset age relative to a date of manufacture, or relative to the date that the asset initiated operation in data processing environment 100 (or another environment not shown). In an example embodiment, life cycle management program 200 compares the determined replacement age for the asset to the actual age of the asset, then compares the difference in age to the threshold condition, and responsive to the comparison to the threshold condition life cycle management program 200 determines whether to provide an alert.

In the previously discussed example, life cycle management program 200 determines a replacement age for server 120 of 4 years (based on information in example event information 350). Life cycle management program 200 compares the determined replacement age for server 120 of 4 years to the actual age of server 120 of 3 years and 8 months and determines a difference in age of 4 months. Then life cycle management program 200 compares the difference in age of 4 months to the threshold condition of 6 months, and since the difference in age is less than the threshold condition, life cycle management program 200 determines to provide an alert (decision step 212, “yes” branch).

In another example, life cycle management program 200 utilizes baseline event information 310 and determines a replacement age for the asset of 10 years (i.e., no adjustment from the manufacturer estimates life span). Life cycle management program 200 compares the determined replacement age for the asset of 10 years to the actual age of server 120 of 3 years and 8 months and determines a difference in age of 6 years and 4 months. Then life cycle management program 200 compares the difference in age of 6 years and 4 months to the threshold condition of 6 months, and since the difference in age is greater than the threshold condition, life cycle management program 200 determines to not provide an alert (decision step 212, “no” branch), and life cycle management program 200 ends.

In step 214, life cycle management program 200 provides an alert. More specifically, in response to determining to provide an alert (decision step 212, “yes” branch), life cycle management program 200 provides an alert. In one embodiment, life cycle management program 200 provides an alert to an individual associated with the asset (e.g., a system administrator, maintenance staff, an asset manager, asset owner, etc.). In one example, life cycle management program 200 provides an alert to the asset owner that indicates a recommended replacement age or date for the asset. In another example, life cycle management program 200 provides an alert to maintenance staff indicating an amount of time remaining before the determined replacement age (from step 210) arrives.

FIG. 4 depicts a block diagram of components of computer 400, which is representative of server 120, client device 130, and asset management service 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media. Software and data 422 are stored in persistent storage 408 for access and/or execution by processors 404 via one or more memories of memory 406. With respect to asset management service 140, software and data 422 includes life cycle management program 200.

In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 may include one or more network interface cards. Communications unit 410 may provide communications through the use of either or both physical and wireless communications links. Software and data 422 may be downloaded to persistent storage 408 through communications unit 410.

I/O interface(s) 412 allows for input and output of data with other devices that may be connected to computer 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data 422 can be stored on such portable computer readable storage media and can be loaded onto persistent storage 408 via I/O interface(s) 412. I/O interface(s) 412 also can connect to a display 420.

Display 420 provides a mechanism to display data to a user and may be, for example, a computer monitor. Display 420 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing assets in a computing environment, the method comprising:
identifying, by one or more processors, a set of information that is associated with a life span of an asset, wherein the asset is a hardware asset or a software asset;
determining, by one or more processors, a weighted rating for the asset based on the identified set of information that is associated with the life span of the asset;
determining, by one or more processors, a replacement age for the asset based on the determined weighted rating for the asset; and
determining, by one or more processors, whether to provide an alert indicating information associated with replacing the asset.

2. The method of claim 1, further comprising:
responsive to determining to provide an alert, providing, by one or more processors, an alert indicating a recommended replacement date for the asset based on the determined replacement age for the asset.

3. The method of claim 1, wherein the set of information comprises a manufacturer provided estimated life span for the asset, ratings corresponding to one or more categories of events associated with the life span of the asset, and weighting factors corresponding to the one or more categories of events associated with the life span of the asset.

4. The method of claim 3, wherein the ratings corresponding to the one or more categories of events associated with the life span of the asset are based on historical events associated with the asset and stored in association with the asset.

5. The method of claim 3, wherein the determining a weighted rating for the asset based on the identified set of information that is associated with the life span of the asset comprises:
determining, by one or more processors, a weighted category rating for the one or more event categories by calculating a product of the rating corresponding to a respective category and the weighting factor corresponding to the respective category; and
determining, by one or more processors, the weighted rating for the asset by calculating a sum of the determined category ratings for the one or more event categories.

6. The method of claim 1, wherein the determining a replacement age for the asset based on the determined weighted rating for the asset comprises:
determining, by one or more processors, a life span adjustment factor for the asset based on the determined weighted rating for the asset; and
determining, by one or more processors, the replacement age for the asset utilizing the determined life span adjustment factor.

7. The method of claim 1, wherein the determining whether to provide an alert indicating information associated with replacing the asset comprises:
determining, by one or more processors, a difference in age between the determined replacement age for the asset and a manufacturer provided estimated life span for the asset;
comparing, by one or more processors, the determined difference in age to a threshold condition indicating a minimum amount of time; and
determining, by one or more processors, whether to provide the alert wherein the alert is provided if the determined difference in age is less than the threshold condition indicating a minimum amount of time.

8. A computer program product for managing assets in a computing environment, the computer program product comprising:
one or more computer readable storage media and program instructions stored on the one or more computer readable storage media, the program instructions comprising:
program instructions to identify a set of information that is associated with a life span of an asset, wherein the asset is a hardware asset or a software asset;
program instructions to determine a weighted rating for the asset based on the identified set of information that is associated with the life span of the asset;
program instructions to determine a replacement age for the asset based on the determined weighted rating for the asset; and
program instructions to determine whether to provide an alert indicating information associated with replacing the asset.

9. The computer program product of claim 8, further comprising program instructions, stored on the one or more computer readable storage media, to:
responsive to determining to provide an alert, provide an alert indicating a recommended replacement date for the asset based on the determined replacement age for the as set.

10. The computer program product of claim 8, wherein the set of information comprises a manufacturer provided estimated life span for the asset, ratings corresponding to one or more categories of events associated with the life span of the asset, and weighting factors corresponding to the one or more categories of events associated with the life span of the asset.

11. The computer program product of claim 10, wherein the ratings corresponding to the one or more categories of events associated with the life span of the asset are based on historical events associated with the asset and stored in association with the asset.

12. The computer program product of claim 10, wherein the program instructions to determine a weighted rating for the asset based on the identified set of information that is associated with the life span of the asset comprises program instructions to:
determine a weighted category rating for the one or more event categories by calculating a product of the rating corresponding to a respective category and the weighting factor corresponding to the respective category; and
determine the weighted rating for the asset by calculating a sum of the determined category ratings for the one or more event categories.

13. The computer program product of claim 8, wherein the program instructions to determine a replacement age for the asset based on the determined weighted rating for the asset comprises program instructions to:
determine a life span adjustment factor for the asset based on the determined weighted rating for the asset; and
determine the replacement age for the asset utilizing the determined life span adjustment factor.

14. The computer program product of claim 8, wherein the program instructions to determine whether to provide an alert indicating information associated with replacing the asset comprises program instructions to:
determine a difference in age between the determined replacement age for the asset and a manufacturer provided estimated life span for the asset;
compare the determined difference in age to a threshold condition indicating a minimum amount of time; and
determine whether to provide the alert wherein the alert is provided if the determined difference in age is less than the threshold condition indicating a minimum amount of time.

15. A computer system for managing assets in a computing environment, the computer system comprising:
one or more computer processors;
one or more computer readable storage media; and
program instructions stored on the computer readable storage media for execution by at least one of the one or more processors, the program instructions comprising:
program instructions to identify a set of information that is associated with a life span of an asset, wherein the asset is a hardware asset or a software asset;
program instructions to determine a weighted rating for the asset based on the identified set of information that is associated with the life span of the asset;
program instructions to determine a replacement age for the asset based on the determined weighted rating for the asset; and
program instructions to determine whether to provide an alert indicating information associated with replacing the asset.

16. The computer system of claim 15, further comprising program instructions, stored on the computer readable storage media for execution by at least one of the one or more processors, to:
responsive to determining to provide an alert, provide an alert indicating a recommended replacement date for the asset based on the determined replacement age for the as set.

17. The computer system of claim 15, wherein the set of information comprises a manufacturer provided estimated life span for the asset, ratings corresponding to one or more categories of events associated with the life span of the asset, and weighting factors corresponding to the one or more categories of events associated with the life span of the asset.

18. The computer system of claim 17, wherein the program instructions to determine a weighted rating for the asset based on the identified set of information that is associated with the life span of the asset comprises program instructions to:
determine a weighted category rating for the one or more event categories by calculating a product of the rating corresponding to a respective category and the weighting factor corresponding to the respective category; and
determine the weighted rating for the asset by calculating a sum of the determined category ratings for the one or more event categories.

19. The computer system of claim 15, wherein the program instructions to determine a replacement age for the asset based on the determined weighted rating for the asset comprises program instructions to:
determine a life span adjustment factor for the asset based on the determined weighted rating for the asset; and
determine the replacement age for the asset utilizing the determined life span adjustment factor.

20. The computer system of claim 15, wherein the program instructions to determine whether to provide an alert indicating information associated with replacing the asset comprises program instructions to:
determine a difference in age between the determined replacement age for the asset and a manufacturer provided estimated life span for the asset;
compare the determined difference in age to a threshold condition indicating a minimum amount of time; and
determine whether to provide the alert wherein the alert is provided if the determined difference in age is less than the threshold condition indicating a minimum amount of time.
